(19) United States
(12) Patent Application Publication
(10) Pub. No.: US 2008/0181621 A1
(43) Pub. Date: Jul. 31, 2008

(54) MANAGEMENT APPARATUS FOR IMAGE FORMING APPARATUS AND MANAGEMENT METHOD THEREOF

(75) Inventors: Toshihiro Ida, Tokyo (JP); Kazuhiro Ogura, Kanagawa-ken (JP); Shinji Makishima, Tokyo (JP); Akihiro Mizutani, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,165

(22) Filed: Jan. 29, 2007

(51) Int. Cl. G03G 15/00

(52) U.S. Cl. 399/8

(57) ABSTRACT

It is an object of the invention to provide a management apparatus for an image forming apparatus that can automatically determine an installation location of the image forming apparatus on the basis of individual authentication information according to an access to the image forming apparatus by a regular user even if the image forming apparatus is moved. The management apparatus for the image forming apparatus of the invention acquires user information of a user authenticated by an image forming apparatus, acquires apparatus information of the image forming apparatus that have authenticated the user information, and specifies an installation location of the image forming apparatus on the basis of the user information acquired and the apparatus information.

### BACKGROUND OF THE INVENTION

1. Field of the Invention

The present invention relates to a management apparatus for an image forming apparatus and a management method thereof that can connect, for example, plural image forming apparatuses and plural terminal apparatuses by a network, provide a desired service in an appropriate image forming apparatus on the basis of a request from a regular user via a terminal apparatus, and manage an installation location of the image forming apparatus.

2. Description of the Related Art

Conventionally, concerning a technique for managing information on installation locations where image forming apparatuses (e.g., MFPs) and terminal apparatuses are installed, a technique for inputting positional information from a terminal apparatus and managing the positional information is disclosed in JP-A-2003-323281.

However, in this method, when an image forming apparatus is moved, positional information has to be inputted from a terminal apparatus again and additional work has to be performed every time an image forming apparatus is moved, leading to complicated work. According to the additional work, it is likely that inconveniences such as input mistakes occur.

A technique for checking whether an access to an image forming apparatus is an access from a regular user (an individual authentication technique) is disclosed in JP-A-07-81154. However, in this example, installation location information of the image forming apparatus is not used.

### SUMMARY OF THE INVENTION

The invention has been devised to solve the problems described above and it is an object of the invention to provide a management apparatus for an image forming apparatus and a management method thereof that can determine whether an access to an image forming apparatus capable of performing individual authentication is an access of a regular user through individual authentication and, when the access is an access from a regular user, automatically determine installation locations of respective image forming apparatuses using information on the individual authentication of the user even if the image forming apparatus is moved.

In order to solve the problems described above, the invention provides a management apparatus for an image forming apparatus that manages an installation location of the image forming apparatus, the management apparatus for an image forming apparatus including a user-information acquiring unit that acquires user information of a user authenticated by an image forming apparatus, an apparatus-information acquiring unit that acquires apparatus information of the image forming apparatus that have authenticated the user information, and an installation-location specifying unit that specifies an installation location of the image forming apparatus on the basis of the user information acquired by the user-information acquiring unit and the apparatus information acquired by the apparatus-information acquiring unit.

The invention provides a management apparatus for an image forming apparatus that manages an installation location of the image forming apparatus, the management apparatus for an image forming apparatus including user-information acquiring means for acquiring user information of a user authenticated by an image forming apparatus, apparatus-information acquiring means for acquiring apparatus information of the image forming apparatus that have authenticated the user information, and installation-location specifying means for specifying an installation location of the image forming apparatus on the basis of the user information acquired by the user-information acquiring means and the apparatus information acquired by the apparatus-information acquiring means.

The invention provides a management method for an image forming apparatus for executing management of an installation location of an image forming apparatus in a computer, the management method for an image forming apparatus including acquiring user information of a user authenticated by an image forming apparatus, acquiring apparatus information of the image forming apparatus that have authenticated the user information, and specifying an installation location of the image forming apparatus on the basis of the user information acquired and the apparatus information.

### DESCRIPTION OF THE DRAWINGS

FIG. 1 is a block diagram showing a structure according to a first embodiment of the invention;

FIG. 2 is a flowchart for explaining an operation of a processing apparatus at the time of execution of processing by an image forming apparatus in FIG. 1;

FIG. 3 is a flowchart for explaining an operation of the processing apparatus after requesting an information management server in FIG. 1 to perform processing;

FIG. 4 is a diagram for explaining contents of processing for updating a table Q in a second embodiment of the invention;

FIG. 5 is a block diagram showing a structure according to a third embodiment of the invention; and

FIG. 6 is a flowchart for explaining an operation of a processing apparatus in FIG. 5.

### DESCRIPTION OF THE EMBODIMENTS

Embodiments of the invention will be explained with reference to the drawings and tables.

### First Embodiment

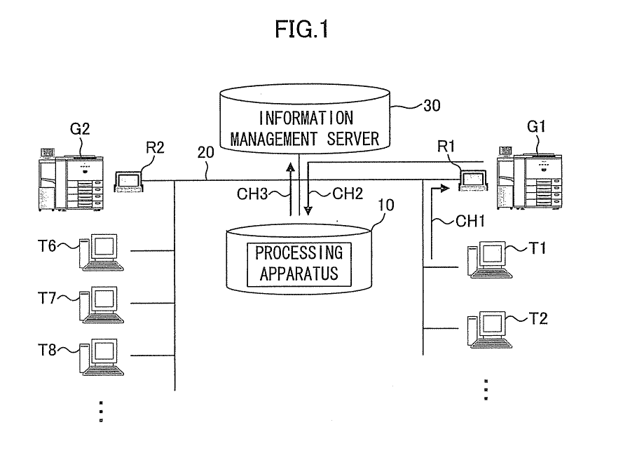

A first embodiment of an image forming network system of the invention shown in FIG. 1 includes image forming apparatuses (e.g., MFPs) G1 and G2, card readers R1 and R2, a processing apparatus (corresponding to a management apparatus for an image forming apparatus of the invention) 10, terminal apparatuses T1, T2, . . . , T6, T7, . . . , a network 20, and an information management server 30.

The image forming apparatuses G1 and G2 are image forming apparatuses that are capable of performing individual authentication via the card readers R1 and R2 as disclosed in JP-A-07-81154 described above.

The information management server 30 is connected to the respective units via the network 20 and stores data indicated by tables A, B, and C described below. A user who uses a terminal apparatus sends a code for individual authentication based on a card or the like of the user to an image forming apparatus, which the user intends to use, through, for example, a route CH1. The code for individual authentication in this case is a unique code including numbers and a character string as shown in the table A and is stored in association with a user name.

The information management server 30 constitutes a first information managing unit (first information managing means) of the invention. In this embodiment, this information management server 30 is provided separately from the processing apparatus 10. However, it goes without saying that the information management server 30 may be provided in the processing apparatus 10 such that the processing apparatus 10 and the information management server 30 constitute the management apparatus for an image forming apparatus of the invention.

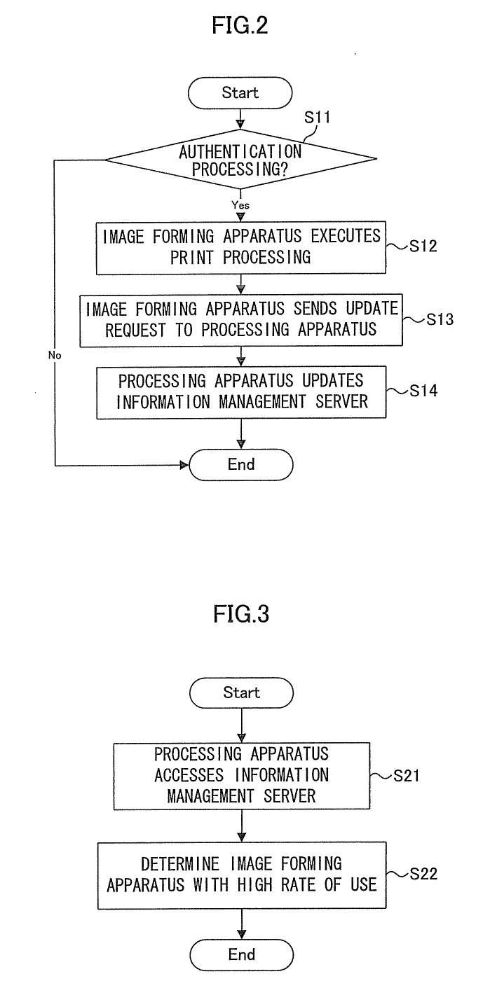

An example of operations of the image forming apparatus will be explained in a flowchart in FIG. 2.

The image forming apparatus, which has received an access, receives a code for individual authentication via the card reader and checks whether the code received is a regular code for individual authentication shown in the table A described later (S11).

When the code for individual authentication is not a regular code (S11, N), the image forming apparatus finishes processing. When the code for individual authentication is a regular code (S11, Y), the image forming apparatus executes print processing (S12). After executing the print processing, the image forming apparatus sends an update request including a user code and a name (apparatus information) of the image forming apparatus, which has performed authentication of the user code, to the processing apparatus 10 through the route CH2 (see FIG. 1) and the processing apparatus 10 receives the name of the image forming apparatus as apparatus information (S13: an apparatus-information acquiring unit or apparatus-information acquiring means).

The processing apparatus 10, which has received the update request, extracts the user code and the image forming apparatus name included in the update request and accesses the information management server 30 through the route CH3. The processing apparatus 10, which has accessed the information management server 30, updates, when a user code matching the user code extracted is present in the table A, contents of the table B representing correspondence between the user code and an image forming apparatus used by a user of the code to match the update request (S14).

TABLE A

| User name | User Code |
|---|---|
| P . . . | USER00001 |
| Q . . . | USER00002 |
| R . . . | USER00003 |

TABLE B

| User Code | Image Forming Apparatus Name |
|---|---|
| USER00001 | Image forming apparatus G1 |
| USER00002 | Image forming apparatus G1 |
| USER00003 | Image forming apparatus G2 |

TABLE C

| User code | Department Name |
|---|---|
| USER00001 | Department BS1 |
| USER00002 | Department BS1 |
| USER00003 | Department BS2 |

After the update request is executed by the information management server 30, as shown in FIG. 3, the processing apparatus 10 accesses the information management server 30 and reads data of the table B and the table C in the storing unit of the processing apparatus 10 (S21: a user-information acquiring unit or user-information acquiring means).

The processing apparatus 1 performs counting of image forming apparatuses used by the users in the departments BS1 and BS2 and calculates a rate of use of the respective departments on the basis of data read to determine that the respective image forming apparatuses are arranged in departments with high rates of use and automatically determine in which departments or around which departments the respective image forming apparatuses are arranged (S22: an installation-location specifying unit or installation-location specifying means).

Therefore, for example, even if an installation location of a certain image forming apparatus is moved, a staff member of a department near a location to which the image forming apparatus is moved uses the image forming apparatus as time elapses. Thus, it is automatically decided that a new installation location of the image forming apparatus is near the department in which the image forming apparatus is used.

### Second Embodiment

A second embodiment of the invention will be explained. This embodiment is a modification of the first embodiment described above. The table B among the tables A, B, and C of the first embodiment is replaced with a table Q described below. In the table Q, data of the image forming apparatus name is replaced with an image forming apparatus name queue.

In this case, an information management server constitutes a second information managing unit.

In other words, the image forming apparatus name queue stores, concerning image forming apparatuses used by respective users, history data of image forming apparatuses for a predetermined continuous plural number of times of use of an image forming apparatus most recently used and image forming apparatuses used earlier than that.

TABLE Q

| User Code | Image Forming Apparatus Name Queue |
|---|---|
| USER00001 | queue00001 |
| USER00002 | queue00001 |
| USER00003 | queue00001 |

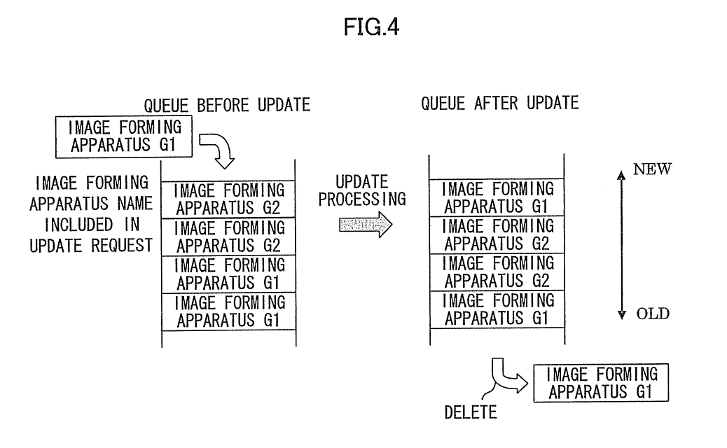

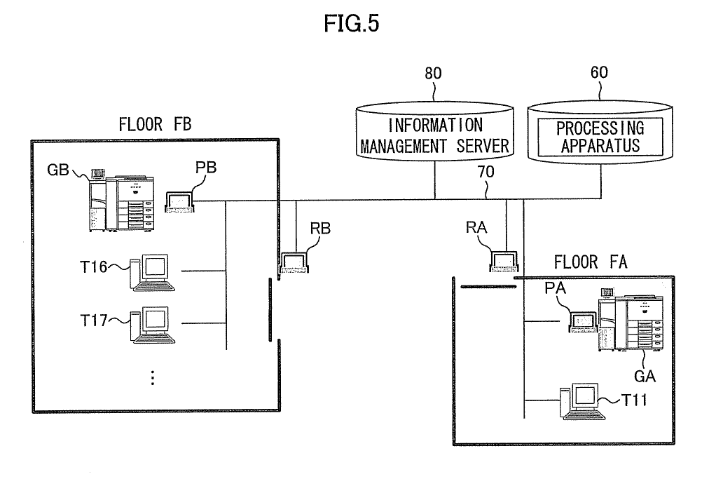

Moreover, explaining the image forming apparatus name queue, the image forming apparatus name queue is formed, for example, as shown in FIG. 4 for each of user codes. It is assumed that, in a queue before update with respect to a certain user code, as shown in FIG. 4(a), image forming apparatuses G1, G1, G2, and G2 are stored in order from an image forming apparatus used earliest. Then, when a new image forming apparatus G1 is used, data stored in an earliest (oldest) position of the queue before update is deleted, the remaining data are sequentially sent to earlier positions, data of the new image forming apparatus G1 is stored in a latest (new) position included in an update request, and the image forming apparatus name queue is updated to be as shown in FIG. 4(b).

In this example, as shown in FIG. 4, data to be stored are data for four times with respect to the respective user codes. However, the data are not limited to this.

Thus, the processing apparatus 10 specifies, with the installation-location specifying unit, a relation between users and departments using at least the table C among the tables A, B, and C and calculates ratios of image forming apparatuses used in the respective departments using the table Q. Consequently, the processing apparatus 10 specifies that positions of the respective image forming apparatuses are set in departments with high rates of use.

### Third Embodiment

A third embodiment of the image forming network system of the invention in which plural image forming apparatuses and plural terminal apparatuses are connected by a network over plural floors will be explained with reference to FIG. 5.

The image forming network system shown in FIG. 5 has floors FA and FB, card readers for room entrance and exit (a room-entrance-and-exit-information acquiring unit or room-entrance-and-exit-information acquiring means of the invention) RA and RB, a processing apparatus 60, an information management server 80, and a network 70 that connects these units.

In a room on the floor FA, an image forming apparatus GA, a card reader PA, and terminal apparatuses T11, . . . are arranged.

In a room on the floor FB, an image forming apparatus GB, a card reader PB, and terminal apparatuses T16, T17, are arranged. In this case, as in the above case, it is assumed that the image forming apparatuses GA and GB have a function capable of performing individual authentication. The information management server 80 manages the table A explained above and tables D, E, and F described below.

The processing apparatus 60 is equivalent to the management apparatus for an image forming apparatus of the invention. The information management server 80 is equivalent to a third information managing unit of the invention.

In the third embodiment, as in the first embodiment, the information management server 80 and the processing apparatus 60 are separately provided. However, it goes without saying that the information management server 80 may be provided in the processing apparatus 60 such that the processing apparatus 60 and the information management server 80 constitute the management apparatus for an image forming apparatus of the invention.

TABLE D

| User Code | Floor Name | Entrance Time | Exit Time |
|---|---|---|---|
| USER00001 | FA | 9:15 | 12:00 |
| USER00002 | FB | 9:00 | 12:30 |
| USER00001 | FA | 13:00 | 14:15 |
| USER00002 | FB | 13:30 | 19:15 |
| USER00001 | FA | 15:00 | 16:15 |

TABLE E

| User Code | Image Forming Apparatus Name | Authentication Time |
|---|---|---|
| USER00001 | Image forming apparatus GA | 10:05 |
| USER00001 | Image forming apparatus GA | 10:06 |
| USER00001 | Image forming apparatus GA | 11:54 |
| USER00002 | Image forming apparatus GB | 17:00 |
| USER00001 | Image forming apparatus GA | 15:00 |

TABLE F

| Card Reader for Entrance and | Entrance and Exit Card Reader |
|---|---|
| Exit Name | Arranged Floor Name |
| Card reader RA | Floor FA |
| Card reader RB | Floor FB |

When individual authentication by the card readers for room entrance and exit RA and RB is performed, the processing apparatus 60 updates the table D on the basis of the individual authentication. In this case, the processing apparatus 60 acquires, through the card readers RA and PB, user codes from data sent from cards and acquires floor names from floor names (table F) allocated to the card readers for room entrance and exit. Room entrance and exit times are set by, for example, the processing apparatus 60.

When individual authentication in the image forming apparatuses GA and GB is performed via the card readers PA and PB, the processing apparatus 60 performs update of the table E. In the case of update of the table E, the processing apparatus 60 acquires image forming apparatus names GA and GB and authentication times from, for example, the image forming apparatuses.

Thus, the processing apparatus 60 specifies, with the installation-location specifying unit (installation-location specifying means), on which floors the image forming apparatuses GA and GB are installed with reference to the tables D and E.

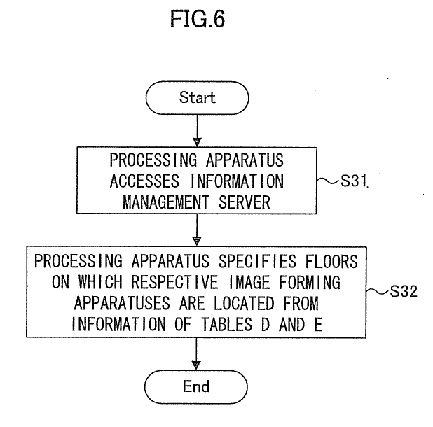

An operation for specifying installation floors of image forming apparatuses by the processing apparatus will be explained with reference to a flowchart in FIG. 6.

The processing apparatus 60 accesses the information management server 80 via the network 70 and reads data of the table D and the table E in a memory of the processing apparatus (S31: user-information acquiring unit (means) and apparatus-information acquiring unit (means)).

The processing apparatus 60, which has read the data, collates authentication times of image forming apparatuses corresponding to user codes in the table E and room entrance and exit times corresponding to the same user codes in the table D. In other words, the processing apparatus 60 specifies on which floors indicated by the table D users are present at the authentication times indicated by the table E, also specifies image forming apparatus names, and specifies on which of the floors FA and FB the image forming apparatuses GA and GB are installed (S32, installation-location specifying means).

As described in detail above, concerning plural image forming apparatuses capable of performing individual authentication connected by a network, when a usual location of a user permitted to use the image forming apparatuses is decided or it is possible to decide the location, the image forming network system according to the embodiment of the invention can determine that an image forming apparatus with a high rate of use by the user is in the usual location of the user.

The image forming network system according to the embodiment of the invention is an image forming network system in which plural terminal apparatuses for users of an organization, in which an arrangement of departments to which the respective users belong is decided, plural image forming apparatuses capable of performing individual authentication for the users, a processing apparatus, and an information management server are connected to one another via a network. The information management server manages a correspondence table A of respective user names and user codes, a correspondence table B of the user codes and image forming apparatus names recently used by the users, and a correspondence table C of the user codes and departments to which the users belong. The image forming apparatuses transmit requests for update of the correspondence table B according to processing of requests from the users subjected to individual authentication to the processing apparatus. The processing apparatus transmits the update requests received from the image forming apparatuses to the information management server, calculates rates of use of the respective image forming apparatuses by the users in the respective departments on the basis of a result updated by the information management server, and associates installation locations of the image forming apparatuses with locations of departments with high rates of use.

In the embodiment of the invention, it is preferable that the information management server manages as a table Q, instead of the image forming apparatuses in the correspondence table B, concerning image forming apparatuses used by the respective users, a history of image forming apparatuses in a predetermined continuous plural number of times of an image forming apparatus most recently used and image forming apparatuses used earlier than that.

Moreover, the image forming network system according to the invention is an image forming network system in which an organization to which users belong is sectioned into respective floors, terminal apparatuses, image forming apparatuses capable of performing individual authentication for the users and room-entrance-and-exit authenticating apparatuses that authenticate room entrance and exit of the users in the respective floors are arranged in the respective floors, and these apparatuses are connected to an information management server and a processing apparatus via a network. The information management server manages a correspondence table D of user codes based on data from the room exit authenticating apparatuses, names of floors on which the users entered and exited from rooms, and times of the room entrance and exit of the users, a correspondence table E of user codes authenticated according to update requests of the image forming apparatuses through the processing apparatus, names of image forming apparatuses that have authenticated the users, and authentication times, and a correspondence table F of floor names allocated to the room-entrance-and-exit authenticating apparatuses. The image forming apparatuses transmit requests for update of the correspondence table E according to processing of requests from the users subjected to individual authentication through the terminal apparatus to the processing apparatus. The processing apparatus transmits the update requests received from the image forming apparatuses to the information management server and specifies, in a unit of floor, locations where the image forming apparatuses are arranged on the basis of a result held or updated by the information management server.

The invention has been explained in detail using the specific forms. However, on the basis of the spirit and the scope of the invention, it is also possible to summarize the invention as follows. When a usual location of a user permitted to use the image forming apparatuses capable of performing individual authentication connected by a network is decided or it is possible to decide the location, it is possible to determine that an image forming apparatus with a high rate of use by the user is in the usual location of the user.

It is possible to apply the user-information acquiring means, the apparatus-information acquiring means, the installation-location specifying means, the first to the third information managing means, and room-entrance-and-exit-information acquiring means explained in the embodiments to a program for causing a computer to execute the method of managing an image forming apparatus explained using the flowcharts described in the embodiments. This program has a function of being recorded in a computer-readable recording medium, read by the computer, and causing the computer to execute the method of managing an imaging forming apparatus of the invention. Concerning such a function, in the explanation of the embodiments, the function of carrying out the invention is recorded in the apparatus in advance. However, the invention is not limited to this. The same function may be downloaded to the apparatus from a network or the same function stored in a recording medium may be installed in the apparatus. A form of the recording medium may be any form as long as the recording medium is a recording medium that can store a program and is readable by the apparatus such as a CD-ROM. The function obtained by installation and download in this way may be realized in cooperation with an OS (operating system) or the like in the apparatus.

What is claimed is:

1. A management apparatus for an image forming apparatus that manages an installation location of the image forming apparatus, the management apparatus for an image forming apparatus comprising:
a user-information acquiring unit configured to acquire user information of a user authenticated by an image forming apparatus;
an apparatus-information acquiring unit configured to acquire apparatus information of the image forming apparatus that has authenticated the user information; and
an installation-location specifying unit configured to specify an installation location of the image forming apparatus on the basis of the user information acquired by the user-information acquiring unit and the apparatus information acquired by the apparatus-information acquiring unit.

2. A management apparatus for an image forming apparatus according to claim 1, wherein the installation-location specifying unit specifies a department to which the user belongs on the basis of the user information and specifies an installation location of the image forming apparatus on the basis of a name of the department and the apparatus information.

3. A management apparatus for an image forming apparatus according to claim 2, comprising a first information managing unit configured to manage a correspondence table A of respective user names and user codes, a correspondence table B of the user codes and apparatus information of image forming apparatuses recently used, and a correspondence table C of the user codes and names of departments to which the users belong, wherein
the installation-location specifying unit specifies an installation location of the image forming apparatus on the basis of information of the respective tables acquired from the first information managing unit.

4. A management apparatus for an image forming apparatus according to claim 3, wherein
the first information managing unit acquires update information of the correspondence table B according to processing of a request from the user authenticated by the image forming apparatus from the image forming apparatus and updates the update information, and
the installation-location specifying unit specifies an installation location of the image forming apparatus on the basis of a result updated by the first information managing unit.

5. A management apparatus for an image forming apparatus according to claim 4, wherein the installation-location specifying unit calculates rates of use of respective image forming apparatuses by users in respective departments on the basis of the result updated by the first information managing unit and associates the installation location of the image forming apparatus with a location of a department with a high rate of use.

6. A management apparatus for an image forming apparatus according to claim 2, comprising a second information managing unit configured to manage a correspondence table A of respective user names and user codes, a history table Q in which, concerning image forming apparatuses used by the respective users, image forming apparatuses for a predetermined continuous plural number of times of use of an image forming apparatus most recently used and image forming apparatuses used earlier than that are stored, and a correspondence table C of the user codes and names of departments to which the users belong, wherein
the installation-location specifying unit specifies an installation location of the image forming apparatus on the basis of information of the respective tables acquired from the second information managing unit.

7. An image forming apparatus according to claim 1, comprising a room-entrance-and-exit-information acquiring unit configured to acquire room entrance and exit information from a room-entrance-and-exit authenticating apparatus that have authenticated room entrance and exit of a user, wherein
the installation-location specifying unit specifies an installation location of the image forming apparatus on the basis of the user information acquired by the user-information acquiring unit, the apparatus information acquired by the apparatus-information acquiring unit, and the room entrance and exit information acquired by the room-entrance-and-exit-information acquiring unit.

8. A management apparatus for an image forming apparatus according to claim 7, comprising a third information managing unit configured to manage a correspondence table D of user codes based on data from the room-entrance-and-exit authenticating apparatus that have authenticated entrance and exit of the user to and from a predetermined room, names of floors on which users entered or exited from rooms, and times of room entrance and exit of the users, a correspondence table E of authenticated user codes, apparatus information of image forming apparatuses that have authenticated the users, and authentication times according to an update request of an image forming apparatus through a processing apparatus, and a correspondence table F of floor names allocated to the room-entrance-and-exit authenticating apparatus, wherein
the installation-location specifying unit specifies an installation location of the image forming apparatus on the basis of information of the respective tables acquired from the third information managing unit.

9. A management apparatus for an image forming apparatus according to claim 8, wherein the third information managing unit acquires, from the image forming apparatus, update information of the correspondence table E according to processing of a request from the user authenticated by the image forming apparatus and updates the update information, and
the installation-location specifying unit specifies an installation location of the image forming apparatus on the basis of a result held or updated by the third information managing unit.

10. A management apparatus for an image forming apparatus that manages an installation location of the image forming apparatus, the management apparatus for an image forming apparatus comprising:
user-information acquiring means for acquiring user information of a user authenticated by an image forming apparatus;
apparatus-information acquiring means for acquiring apparatus information of the image forming apparatus that have authenticated the user information; and
installation-location specifying means for specifying an installation location of the image forming apparatus on the basis of the user information acquired by the user-information acquiring means and the apparatus information acquired by the apparatus-information acquiring means.

11. A management apparatus for an image forming apparatus according to claim 10, wherein the installation-location specifying means specifies a department to which the user belongs on the basis of the user information and specifies an installation location of the image forming apparatus on the basis of a name of the department and the apparatus information.

12. A management apparatus for an image forming apparatus according to claim 11, comprising first information managing means for managing a correspondence table A of respective user names and user codes, a correspondence table B of the user codes and apparatus information of image forming apparatuses recently used, and a correspondence table C of the user codes and names of departments to which the users belong, wherein
the installation-location specifying means specifies an installation location of the image forming apparatus on the basis of information of the respective tables acquired from the first information managing means.

13. A management apparatus for an image forming apparatus according to claim 12, wherein
the first information managing means acquires update information of the correspondence table B according to processing of a request from the user authenticated by the image forming apparatus from the image forming apparatus and updates the update information, and
the installation-location specifying means specifies an installation location of the image forming apparatus on the basis of a result updated by the first information managing means.

14. A management apparatus for an image forming apparatus according to claim 13, wherein the installation-location specifying means calculates rates of use of respective image forming apparatuses by users in respective departments on the basis of the result updated by the first information managing means and associates the installation location of the image forming apparatus with a location of a department with a high rate of use.

15. A management apparatus for an image forming apparatus according to claim 11, comprising second information managing means for managing a correspondence table A of respective user names and user codes, a history table Q in which, concerning image forming apparatuses used by the respective users, image forming apparatuses for a predetermined continuous plural number of times of use of an image forming apparatus most recently used and image forming apparatuses used earlier than that are stored, and a correspondence table C of the user codes and names of departments to which the users belong, wherein
the installation-location specifying means specifies an installation location of the image forming apparatus on the basis of information of the respective tables acquired from the second information managing means.

16. An image forming apparatus according to claim 10, comprising room-entrance-and-exit-information acquiring means for acquiring room entrance and exit information from room-entrance-and-exit authenticating means for authenticating room entrance and exit of a user, wherein
the installation-location specifying means specifies an installation location of the image forming apparatus on the basis of the user information acquired by the user-information acquiring means, the apparatus information acquired by the apparatus-information acquiring means, and the room entrance and exit information acquired by the room-entrance-and-exit-information acquiring means.

17. A management apparatus for an image forming apparatus according to claim 16, comprising third information managing means for managing a correspondence table D of user codes based on data from the room-entrance-and-exit authenticating means for authenticating entrance and exit of the user to and from a predetermined room, locations where users entered or exited from rooms, and times of room entrance and exit of the users, a correspondence table E of authenticated user codes, apparatus information of image forming apparatuses that have authenticated the users, and authentication times according to an update request of an image forming apparatus through a processing apparatus, and a correspondence table F of locations allocated to the room-entrance-and-exit authenticating means, wherein
the installation-location specifying means specifies an installation location of the image forming apparatus on the basis of information of the respective tables acquired from the third information managing means.

18. A management apparatus for an image forming apparatus according to claim 17, wherein the third information managing means acquires, from the image forming apparatus, update information of the correspondence table E according to processing of a request from the user authenticated by the image forming apparatus and updates the update information, and
the installation-location specifying means specifies an installation location of the image forming apparatus on the basis of a result held or updated by the third information managing means.

19. A management method for an image forming apparatus for executing management of an installation location of an image forming apparatus in a computer, the management method for an image forming apparatus comprising:
acquiring user information of a user authenticated by the image forming apparatus;
acquiring apparatus information of the image forming apparatus that have authenticated the user information; and
specifying an installation location of the image forming apparatus on the basis of the user information acquired and the apparatus information.

20. A management method for an image forming apparatus according to claim 19, wherein a name of a department to which the user belongs is specified on the basis of the user information and an installation location of the image forming apparatus is specified on the basis of a name of the department and the apparatus information.
